(19) United States
(12) Patent Application Publication
(10) Pub. No.: US 2026/0302488 A1
(43) Pub. Date: Oct. 1, 2026

(54) BATTERY ENCLOSURE

(71) Applicant: Dyson Technology Limited, Malmesbury, Wiltshire (GB)

(72) Inventor: James Thomas WRIGHT, Bristol (GB)

(21) Appl. No.: 19/477,832

(22) PCT Filed: Apr. 3, 2024
(86) PCT No.: PCT/IB2024/053222

§ 371 Date: Oct. 23, 2025

(30) Foreign Application Priority Data
Apr. 27, 2023 (GB) 2306191.4

(51) Int. Cl. H01M 50/262; A47L 9/28; H01M 50/211; H01M 50/247; H01M 50/284

(52) U.S. Cl. CPC H01M 50/262; A47L 9/2884; H01M 50/211; H01M 50/247; H01M 50/284; H01M 2220/30

(57) ABSTRACT

A battery including one or more pouch cells and a pouch cell enclosure. The pouch cell enclosure includes first and second walls spaced apart in a cell stack direction to define a cell-receiving space therebetween in which the one or more pouch cells are received. The first wall has an inner surface facing the cell-receiving space and an opposite outer surface facing away from the cell-receiving space. The pouch cell enclosure further includes a fastener for mounting an external component to the first wall. The fastener includes a head pressed into the first wall such that the first wall is deformed around the fastener to retain the fastener in the first wall, and a shaft extending from the head to project from, and beyond, the outer surface of the first wall.

### BACKGROUND

Batteries, such as those used in consumer devices, are typically formed of a plurality of battery cells (or just “cells”). Battery cells (such as lithium-ion cells) come in various formats. Known battery cells often have a cylindrical shape or a rectangular (or cuboid) shape. One type of rectangular battery cell that is increasingly being used in devices is a pouch cell. A pouch cell includes a laminated battery architecture contained within a flexible (i.e. non-rigid) pouch, which is commonly formed of an aluminium coated plastic film. Tabs are provided at one end (or two opposite ends) of the pouch cell to provide terminals that allow electrical connection of the pouch cell to other pouch cells in a pouch cell stack or to the electrical components of a device.

The use of a pouch rather than a rigid housing (as is the case with other types of battery cell) reduces the overall weight and volume of the cell. Likewise, the rectangular (or cuboid) shape provides a more efficient use of space than a cylindrical shape when multiple cells are packaged together. (i.e. in a cell stack).

### SUMMARY

In a first aspect, there is disclosed a pouch cell enclosure comprising:
first and second walls spaced apart in a cell stack direction so as to define a cell-receiving space therebetween for receipt of one or more pouch cells, the first wall having an inner surface facing the cell-receiving space and an opposite outer surface facing away from the cell-receiving space; and
a fastener for mounting an external component to the first wall, the fastener comprising:
   a head pressed into the first wall such that the first wall is deformed around the fastener to retain the fastener in the first wall; and
   a shaft extending from the head so as to project from, and beyond, the outer surface of the first wall.

As will be described below, the use of a fastener of the type that is retained by deformation of the wall about a head of the fastener, can provide a more compact pouch cell enclosure while limiting risk of damage to pouch cells held in the cell-receiving space.

One issue that can be faced with the use of pouch cells is that, because they are highly efficient in their use of space, it can be problematic finding space to incorporate fasteners in an enclosure including pouch cells (i.e. without increasing the size of the enclosure to provide such space). In batteries that include cylindrical cells, the shape of a cylindrical cell means that when they are stacked side-by-side there are inevitably (asteroid-shaped) gaps formed between the cells. These gaps can be used for positioning fasteners that allow mounting of the battery within a device (or to further components of a device).

Such gaps are not present in a pouch cell stack for accommodating fasteners, so positioning fasteners within the cell-receiving space is not possible (or is at least not desirable as it may present a risk of damage to the pouch of a pouch cell). This means that additional volume must be provided to accommodate fasteners, which at least partly counteracts the increase in energy density provided by the space efficiency of a pouch cell stack.

Providing a fastener that is able to be embedded in and retained in the wall of the enclosure avoids both the need for the fastener to project into the cell-receiving space and for additional volume to be provided to accommodate the fastener.

Optional features of the first aspect will now be set out. These are applicable singly or in any combination with any aspect.

The fastener may comprise teeth. Deformed material of the first wall may be received between the teeth. The teeth (and the deformed material therebetween) may aid in restricting movement of the fastener relative to the first wall in at least one direction. The at least one direction may, for example, be a circumferential direction (i.e., receipt of deformed material between the teeth may restrict rotation of the fastener about a central axis of the fastener).

The teeth may be provided on a side of the head of the fastener from which the shaft extends. Each tooth may be provided on the head. Each tooth may be provided on the shaft. Each tooth may be provided on a collar (or may form a collar) extending radially from and that is spaced from the head (i.e., in a direction along the shaft).

Each tooth may extend radially. For the avoidance of doubt, the “radially” refers to a direction extending outwardly from a central axis of the shaft (i.e., in the radial direction).

Each tooth may project in an axial direction (e.g., a direction substantially parallel to a central axis of the shaft).

The teeth may be spaced circumferentially about a central axis of the fastener. The teeth may be spaced evenly in the circumferential direction. Thus, the teeth may define circumferentially spaced gaps (in which deformed material is received).

The head may comprise a circumferential recess in which deformed material of the first wall is received. The shaft may comprise a circumferential recess in which deformed material of the first wall is received. When the fastener comprises a collar (as described above) a circumferential recess, which deformed material of the first wall is received, may be provided between the collar and the head.

The recess may extend fully about the shaft or head of the fastener. The recess may be disposed proximate to the teeth.

The receipt of deformed material of the first wall in the recess may retain the fastener against axial movement (e.g., out of the first wall).

The shaft may be threaded. A thread of the shaft may be provided on a portion of the shaft projecting beyond the outer surface of the first wall. The thread may allow mounting of e.g., a nut to the shaft for securing a component to the battery.

The fastener may be a unitary (i.e., integrally formed) piece.

The head of the fastener may be substantially fully received within the first wall.

The fastener may comprise a surface (e.g., a planar surface) opposite the side of the head from which the shaft extends. The surface of the head may be internally located within the first wall (i.e., the surface may be disposed between the inner and outer surfaces of the first wall). The surface of the head may alternatively be substantially flush with the inner surface of the first wall. The surface of the head may alternatively recess into the inner surface of the first wall. Arranging the head so as to be in one of these positions ensures that the head does not penetrate into the cell-receiving space (where it could otherwise cause damage to a pouch cell received in the cell-receiving space).

The first wall may have a thickness that is 0.3 mm or greater, 0.6 mm or greater or 0.8 mm or greater. The first wall may, for example, have a thickness that is 1.5 mm, or e.g., less, or mm or less. The thickness may, for example, be from 0.3 mm to 2 mm.

In a second aspect, there is disclosed a battery comprising:
one or more pouch cells; and
a pouch cell enclosure comprising:
   first and second walls spaced apart in a cell stack direction so as to define a cell-receiving space therebetween in which the one or more pouch cells are received, the first wall having an inner surface facing the cell-receiving space and an opposite outer surface facing away from the cell-receiving space; and
   a fastener for mounting an external component to the first wall, the fastener comprising:
      a head pressed into the first wall such that the first wall is deformed around the fastener to retain the fastener in the first wall; and
      a shaft extending from the head so as to project from, and beyond, the outer surface of the first wall.

The battery of the second aspect is advantageous for the same reasons as discussed above with respect to the first aspect.

Optional features of the second aspect will now be set out. These are applicable singly or in any combination with any aspect.

Each pouch cell may be oriented such that internal layers of the pouch cell are substantially parallel to the first wall.

Each pouch cell may have opposite first and second major faces, which may respectively face towards the first and second compression members. The major faces of each pouch cell may be substantially perpendicular to the cell stack direction. The layers of an internal layered structure of each pouch cell may be substantially parallel to the major faces of the pouch cell.

Each pouch cell may comprise opposite lateral sides (e.g., aligned with the lateral sides of the enclosure) and may comprise opposite ends. Each pouch cell may comprise at least two terminals, which may be at the same end or at opposite ends of the pouch cell.

At least one of the one or more pouch cells may be in contact with the inner surface of the first wall. A major face of one of the at least one pouch cell may be in contact with the inner surface of the first wall. Substantially the entirety of the major face of the at least one pouch cell may be in contact with the inner surface of the first wall.

In a third aspect there is disclosed a battery assembly comprising:
a battery according to the second aspect; and
an external component mounted to the battery, the external component comprising a mounting portion having an aperture therethrough, the shaft of the fastener extending through the aperture, and
wherein a nut is secured to the shaft of the fastener such that the mounting portion is retained between the nut and the first wall of the pouch cell enclosure.

The battery assembly of the third aspect is advantageous for the same reasons as discussed above with respect to the first aspect.

Optional features of the third aspect will now be set out. These are applicable singly or in any combination with any aspect.

The external component may comprise, for example, electronic circuitry, which may be in the form of a printed circuit board assembly. This may provide a battery management system configured to control operation of the battery. The external component may, for example, include a connector for connection to an appliance (such as a vacuum cleaner).

An insulating layer provided between the first wall and the external component (e.g., the printed circuit board assembly). The insulating layer may be an electrically insulating layer (e.g., may be formed of an electrically insulating material. The insulating layer may be a thermally insulating layer (e.g. may be formed of a thermally insulating material).

In a fourth aspect there is disclosed a vacuum cleaner comprising a battery assembly according to the third aspect.

In a fifth aspect there is disclosed a method of forming a pouch cell enclosure, the method comprising:
pressing the head of a fastener into a first wall such that the first wall is deformed around the fastener to retain the fastener in the first wall, and such that a shaft extending from the head of the fastener projects from, and beyond, a surface of the first wall; and
assembling the first wall with a second wall, the first and second walls spaced apart in a cell stack direction so as to define a cell-receiving space therebetween for receipt of one or more pouch cells;
wherein the shaft of the fastener extends from the head of the fastener in a direction away from the cell-receiving space.

Optional features of the fifth aspect will now be set out. These are applicable singly or in any combination with any aspect.

The surface of the wall from which the shaft extends may be a first surface of the first wall (which may ultimately be an outer surface of the first wall facing away from the cell-receiving space when the enclosure is formed). The opposite surface of the wall may be a second surface (which may ultimately be an inner surface of the first wall facing the cell-receiving space when the enclosure is formed).

The step of pressing the head of the fastener into the first wall may comprise pressing the head of the fastener into the first surface. In such embodiments, a hole may be formed in the first wall prior to the pressing step (the shaft may be received through the hole in the pressing step).

Alternatively, the step of pressing the head of the fastener into the first wall may comprise pressing the head of the fastener into the second surface of the first wall. As may be appreciated, pressing the head into the first wall may comprise pressing the first wall onto the head. Pressing the head into the second surface of the first wall may comprise, for example, positioning the shaft in a recess formed in an anvil, with the head exposed externally of the recess, and pressing the first wall onto the head. Such embodiments may be particularly suited to a fastener of the type comprising a collar as described with respect to the first aspect.

In a seventh aspect, there is disclosed a method of forming a battery comprising:
forming a pouch cell enclosure according to the method of the sixth aspect; and
positioning one or more pouch cells in the cell-receiving space of the pouch cell enclosure such that the internal layers of each pouch cell are substantially parallel to the first wall.

In an eighth aspect, there is disclosed a method of forming a battery assembly, the method comprising:
forming a battery according to the method of the seventh aspect; and
mounting an external component to the battery, the external component comprising a mounting portion having an aperture extending therethrough, and wherein mounting the external component to the battery comprises passing the shaft of the fastener through the aperture of the mounting portion and securing a nut to the shaft to retain the mounting portion between the nut and the first wall of the pouch cell enclosure.

### BRIEF DESCRIPTION OF THE DRAWINGS

FIG. 1A is an exploded perspective view of a battery assembly;

FIG. 1B is a side section view of the battery assembly of FIG. 1A;

FIG. 1C is a detailed section view of a fastener of the battery assembly of FIG. 1A;

FIG. 2A is a top view of a fastener according to a first embodiment;

FIG. 2B is a side view of the fastener of FIG. 2A;

FIG. 3A is a top view of a fastener according to a second embodiment; and

FIG. 3B is a side view of the fastener of FIG. 3A.

### DETAILED DESCRIPTION

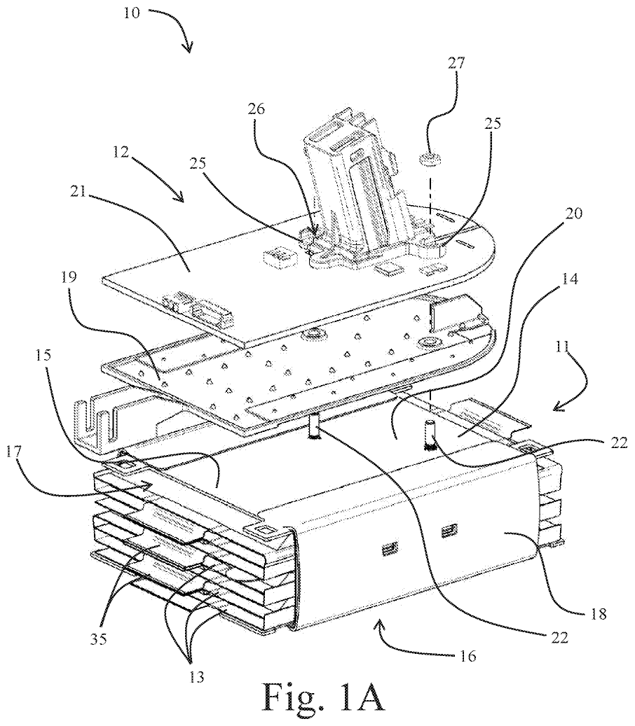

FIGS. 1A, 1B and 1C illustrate a battery assembly 10 for a vacuum cleaner. The battery assembly 10 includes a battery 11 and an external component, in the form of a printed circuit board assembly 12 (which may provide a battery management system of the battery assembly 10), mounted to the battery 11.

The battery 11 includes a plurality of pouch cells 13 that are partly enclosed by a pouch cell enclosure 14. Each pouch cell 13 has a generally (flattened) cuboid shape, with two opposite major faces (providing upper and lower surfaces of each pouch cell as illustrated).

The pouch cells 13 are stacked on top of one another such that their major faces bear against one another. To allow electrical connection between the stacked pouch cells 13, each pouch cell 13 includes two terminals 35 at opposite ends of the pouch cell 13. Each terminal 15 is in the form of a tab which extends internally into its respective pouch cell 13 so as to electrically connect to an internal layered structure of the pouch cell 13.

The pouch cell enclosure 14 includes first 15 and second 16 walls, which are respectively upper and lower walls as illustrated. The first 15 and second 16 walls are spaced apart in a cell stack direction so as to define a (substantially cuboid) cell-receiving space 17 therebetween, in which the pouch cells 13 are received. The pouch cell enclosure 14 also includes lateral side walls 18 provided on opposite sides of the cell-receiving space 17, and which extend between the first 15 and second 16 walls (generally vertically as illustrated).

An insulating layer 19 is provided between an outer surface 20 of the first wall 15 of the pouch cell enclosure 14 and the printed circuit board assembly 12. In particular, the insulating layer 19 is sandwiched between a plate 21 of the printed circuit board assembly 12 (a housing of which provides an external wall of the vacuum cleaner when assembled) and the outer surface 20 of the first wall 15.

To mount the battery 11 to the printed circuit board assembly 12, the pouch cell enclosure 14 includes two spaced apart fasteners 22. Each fastener 22 includes a head 23 that is pressed into the first wall 15 and a shaft 24 that extends from the head 23 so as to project from, and beyond, the outer surface 20 of the first wall 15. The printed circuit board assembly 12 includes two mounting portions 25 that have apertures 26 positioned so as to correspond to the fasteners 22. The shafts 24 of the two fasteners 22 extend through these apertures 26, and each is provided with a nut 27 (only one of which is visible in FIG. 1A) such that the mounting portions 25 are retained between the nut 27 and the first wall 20.

As is most apparent from FIG. 1C, the head 13 of each fastener 22 is fully contained within the first wall 15 (i.e. does not project beyond the first wall 15). As a result, each fastener 22 does not penetrate into the cell-receiving space 17 (where it could otherwise cause damage to a pouch cell 13 held therein). Rather, a surface 28 of the head 23 of the fastener 22 (on an opposite side of the head 23 from which the shaft 24 extends) is substantially flush with an inner surface 29 of the first wall 15 (facing the cell-receiving space 17 and opposite the outer surface 20).

Although not immediately apparent from FIG. 1C, the head 23 of the fastener 22 is retained in the first wall 15 by deformation of the first wall 15 around the head 23 of the fastener 22. This is achieved by the shape of the fastener 22 and the way it is installed in the first wall 15. This is described further below.

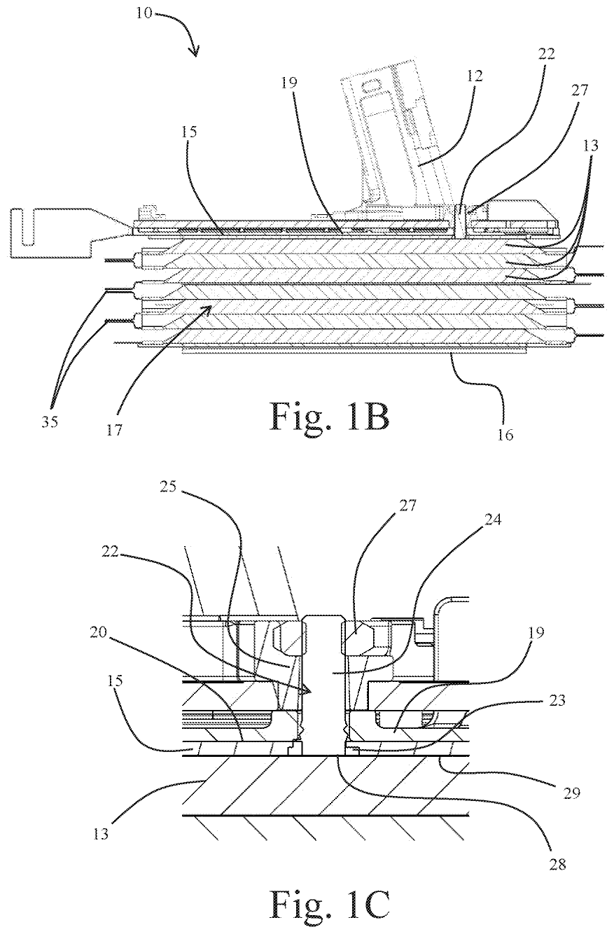

FIGS. 2A and 2B illustrate one example of a fastener 22′ that may be used in the battery 10 assembly described above. The fastener 22′ includes a cylindrical head 23 and a threaded shaft 24 that extends from the head 23 (the head 23 having a greater diameter than the shaft 24).

The head 23 has a substantially planar first surface 28 (opposite a second surface 30 from which the shaft 24 extends) that is flush with the inner surface 29 of the first wall 15 in which the fastener 22′ is received. A plurality of teeth 31 project axially (i.e. in the direction of extension of the shaft 23) from the second surface 30 of the head 23 of the fastener 22′. The teeth 31 are evenly, circumferentially spaced about a base of the shaft 24 (where it connects to the head 23), so as to define a plurality of evenly spaced gaps 32 therebetween.

The shaft 24 includes a circumferential recess 33 that extends fully about the shaft 24 in proximity to the head 23. Deformed portions of the first wall 15 are received in both this recess 33 and between the teeth 31 provided on the head 23. This interaction between the first wall 15 and the head 23 and shaft 24 of the fastener 22′ retains the fastener 22′ in the first wall 15.

The fastener 22′ is installed by pressing the head 23 into the first wall 15, in particular into the inner surface 29 of the first wall 15. To accommodate the shaft 24, a hole (not shown) is first formed in the first wall 15 through which the shaft 24 extends during the pressing action. As the head 23 is pressed into the inner surface 29 the material of the first wall 15 is deformed by the head 23 and the teeth 31 projecting from the head 23. This deformed material is forced between the teeth 31 so as to be received in the gaps 32 between the teeth 31. The deformed material is also forced into the circumferential recess 33 formed in the shaft 24. The material received in the gaps 32 aids in preventing rotation of the fastener 22′ about a central axis of the shaft, and the material received in the recess 33 aids in preventing axial movement of the fastener 22′.

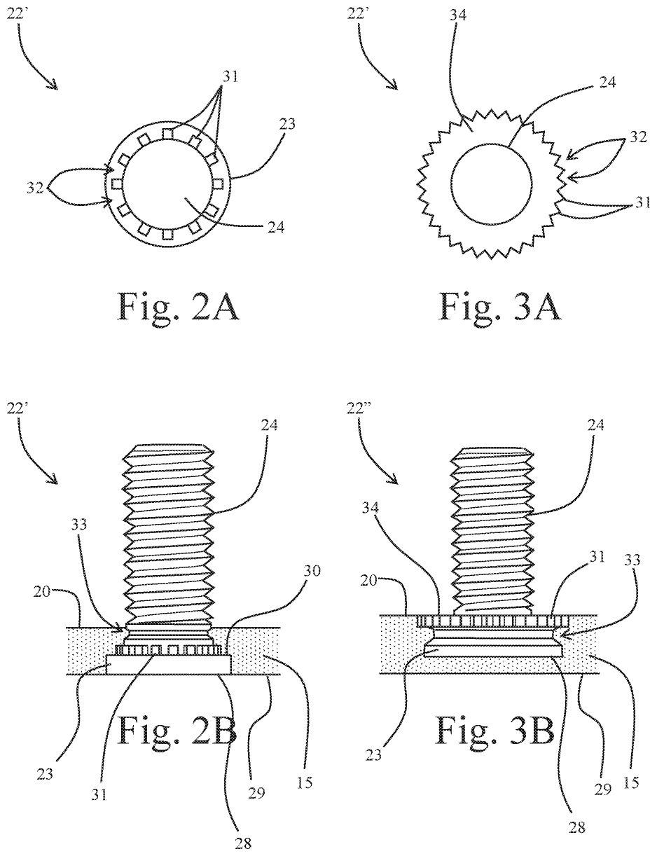

The fastener 22″ of FIGS. 3A and 3B, again, includes a head 23 and a shaft 24 extending from the head 23. In this case, however, the fastener 22″ includes teeth 31 that form part of a collar 34 that projects radially from the shaft 24. Each tooth 31 has a tapered (i.e. triangular shape) and extends radially to provide the collar 34 with a serrated outer edge. The fastener 22″ includes a circumferential recess 33 that is defined between the collar 34 and the head 23.

As is particularly apparent from FIG. 3B, a first surface 28 of the head 23 is positioned within the first wall 15 (i.e. between the inner 29 and outer 20 surfaces of the first wall 15). This is at least partly a result of the installation method associated with this type of fastener 22″. In this case, the head 23 of the fastener 22″ is pressed into the outer surface 20 of the first wall 15. This can be achieved, for example, by locating the shaft 24 in a hole formed in an anvil (the collar seated on an external surface of the anvil) such that the head 23 is exposed, and pressing the first wall 15 onto the head 23 (i.e. to press the head into the first wall 15). Again, this deforms the material of the first wall 15 causing it to be received between the teeth 31 and within the recess 33 which aids in retaining the head 23 within the first wall 15.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A battery comprising:
one or more pouch cells; and
a pouch cell enclosure comprising:
first and second walls spaced apart in a cell stack direction so as to define a cell-receiving space therebetween in which the one or more pouch cells are received, the first wall having an inner surface facing the cell-receiving space and an opposite outer surface facing away from the cell-receiving space; and
a fastener for mounting an external component to the first wall, the fastener comprising:
a head pressed into the first wall such that the first wall is deformed around the fastener to retain the fastener in the first wall; and
a shaft extending from the head so as to project from, and beyond, the outer surface of the first wall.

2. The battery according to claim 1, wherein the fastener comprises teeth, deformed material of the first wall being received between the teeth.

3. The battery according to claim 2, wherein the teeth are provided on a side of the head of the fastener from which the shaft extends.

4. The battery according to claim 2, wherein each tooth extends radially.

5. The battery according to claim 2, wherein each tooth projects in an axial direction.

6. The battery according to claim 2, wherein the teeth are spaced circumferentially about a central axis of the fastener.

7. The battery according to claim 1, wherein the head or the shaft comprises a circumferential recess in which deformed material of the first wall is received.

8. The battery according to claim 7, wherein the circumferential recess extends fully about the head or the shaft of the fastener.

9. The battery according to claim 1, wherein a surface of the head of the fastener, opposite the side of the head from which the shaft extends, is:
internally located within the first wall; or
substantially flush with the inner surface of the first wall; or
recessed into the inner surface of the first wall.

10. The battery according to claim 1, wherein the shaft comprises a thread provided on a portion of the shaft projecting beyond the outer surface of the first wall.

11. The battery according to claim 1, wherein the first wall has a thickness of between 0.3 mm and 2 mm.

12. The battery according to claim 1, wherein each pouch cell is oriented such that internal layers of the pouch cell are substantially parallel to the first wall.

13. The battery according to claim 1, wherein at least one of the one or more pouch cells is in contact with the inner surface of the first wall.

14. A battery assembly comprising:
a battery according to claim 1; and
an external component mounted to the battery, the external component comprising a mounting portion having an aperture therethrough, the shaft of the fastener extending through the aperture, and
wherein a nut is secured to the shaft of the fastener such that the mounting portion is retained between the nut and the first wall of the pouch cell enclosure.

15. The battery assembly according to claim 14, wherein the external component comprises a printed circuit board assembly.

16. The battery assembly according to claim 14, comprising an insulating layer provided between the first wall and the external component.

17. A vacuum cleaner comprising a battery assembly according to claim 14.

18. (canceled)

19. (canceled)

20. (canceled)
